(19) United States
(12) Patent Application Publication
(10) Pub. No.: US 2014/0242446 A1
(43) Pub. Date: Aug. 28, 2014

(54) Single Cell for a Battery, and a Battery

(71) Applicants: Claus-Rupert Hohenthanner, Hanau (DE); Rainer Kaufmann, Stuttgart (DE); Silvio Lieb, Dresden (DE); Jens Meintschel, Bernsdorf (DE); Dirk Schroeter, Winnenden (DE)

(72) Inventors: Claus-Rupert Hohenthanner, Hanau (DE); Rainer Kaufmann, Stuttgart (DE); Silvio Lieb, Dresden (DE); Jens Meintschel, Bernsdorf (DE); Dirk Schroeter, Winnenden (DE)

(73) Assignee: Daimler AG, Stuttgart (DE)

(21) Appl. No.: 14/236,496

(22) PCT Filed: Jul. 18, 2012
(86) PCT No.: PCT/EP2012/003020

§ 371 Date: Apr. 30, 2014

(30) Foreign Application Priority Data
Aug. 2, 2011 (DE) 10 2011 109 179.7

(51) Int. Cl. H01M 2/30

(52) U.S. Cl. CPC H01M 2/305
USPC 429/158; 429/179

(57) ABSTRACT

A single cell for a battery includes two housing parts, a cell frame, an electrode foil stack situated between the housing parts, and an insulating element situated between the housing parts. The insulating element electrically separates the two housing parts from one another. The insulating element has dimensions such that in the assembled state of the single cell the insulating element projects, at least in part, beyond a first housing part at the edge, forming a projection. The first housing part is enclosed, at least in part, by the insulating element at an edge.

### BACKGROUND AND SUMMARY OF THE INVENTION

Exemplary embodiments of the invention relate to a single cell for a battery, comprising two housing parts, a cell frame, an electrode foil stack situated between the housing parts, and at least one insulating element, situated between the housing parts, by means of which the housing parts are electrically separated from one another, the insulating element having dimensions such that in the assembled state of the single cell the insulating element projects, at least in part, beyond one of the housing parts at the edge, forming a projection. The invention further relates to a battery having a number of single cells.

A high-voltage battery for a vehicle, in particular an electric vehicle or a vehicle operated with fuel cells, is formed from a number of single cells connected to one another in series and/or in parallel, an electronics system, and a cooling/heating system, these components being situated in a housing. In a single cell designed as a flat-frame cell, an electrode foil stack is enclosed by two planar enveloping metal sheets, or one planar and one shell-shaped enveloping metal sheet, or two shell-shaped enveloping metal sheets. The enveloping metal sheets are electrically separated from one another by a housing frame and/or by an insulating element, and form the poles of the single cell. Heat loss resulting during charging and discharging of the single cell is conducted to a narrow side of the single cell via the appropriately thickened enveloping metal sheets, and is supplied to a heat conducting plate through which air conditioner refrigerant and/or a cooling liquid may flow. A thermally conductive foil is situated between the enveloping metal sheet and the cooling plate for electrically insulating same. To improve the heat transfer, the enveloping metal sheets are folded in the area of the cooling plate, parallel thereto, by an angle of 90°. For mechanically forming a cell system and for the electrical connection in series, the single cells are stacked next to one another and pressed by the pole plates in the axial direction, i.e., vertically with respect to the electrode stack.

A hot pressing (sealing) process is preferably usable to close off the single cell. For this purpose, the housing frame and/or the insulating element is/are made of a thermoplastic material, at least in the area of a sealing seam. The insulating element usually has a foil-like design, since a barrier effect is low due to the electrically insulating material of the insulating element, as the result of which undesirable diffusion processes, such as water penetrating into the single cell and electrolyte exiting the single cell, may result.

The foil-like design of the insulating element cannot ensure sufficient electrical insulation between the enveloping metal sheets. For example, leakage currents may occur between the enveloping metal sheets due to soiling and moisture, which may result in undesirable discharges of the single cell, and even short circuits. To solve this problem, it is known to enlarge the insulating element beyond the edge of one of the enveloping metal sheets, the other of the enveloping metal sheets having dimensions corresponding to those of the insulating element. Depending on soiling and possible penetration of moisture over the service life of the battery, the insulating element is enlarged with a circumferential projection of 1 millimeter to 3 millimeters, preferably 1.5 millimeter. Due to the mechanical sensitivity of the insulating element, the projection of the insulating element is usually sealed onto the shell-shaped enveloping metal sheet or a supporting frame situated on the shell-shaped enveloping metal sheet.

Exemplary embodiments of the present invention are directed to a single cell for a battery that is improved over the prior art, and a battery.

In accordance with exemplary embodiments of the present invention, a single cell for a battery comprises two housing parts, a cell frame, an electrode foil stack situated between the housing parts, and at least one insulating element, situated between the housing parts, by means of which the housing parts are electrically separated from one another. The insulating element is used to electrically insulate the housing parts from one another, and to electrically insulate the electrode foil stack from the housing parts. The insulating element preferably has a foil-like design in order to reduce diffusion processes resulting from loss of electrolyte from the single cell, for example, and which decrease the service life. Since so-called leakage currents may occur between the housing parts due to soiling or moisture, the insulating element has dimensions such that in the assembled state of the single cell the insulating element projects, at least in part, beyond a first housing part at the edge, forming a projection.

Due to the mechanical sensitivity of the insulating element, the projection of the insulating element is usually sealed onto the other of the housing parts, i.e., a second housing part, at the edge. The second housing part has dimensions such that it projects beyond the first housing part in the assembled state of the single cell, forming a projection at the edge. The projection of the second housing part has a design corresponding to the projection of the insulating element, so that in the assembled state of the single cell the insulating element terminates at the second housing part, at the edge. This results in a leakage path, necessary for electrically insulating housing parts from one another, along the free surface of the insulating element, but also results in increased installation space of the single cell. The leakage path is defined as the shortest distance between the housing parts along a surface of the insulating element.

According to the invention, therefore, at least one of the housing parts is enclosed, at least in part, by the insulating element at the edge.

The enclosure, at least in part, of the first housing part at the edge provides the leakage path, necessary for electrically insulating the housing parts from one another, in a way that optimizes installation space. At the edge, the insulating element is guided at at least one edge from an inner side to an outer side of the first housing part. It is thus possible to produce the second housing part with dimensions such that in the assembled state of the single cell the second housing part terminates at the first housing part at the edge, which allows a reduction in installation space and manufacturing costs of the single cell. In this regard, the inner side of the housing part is a side of the housing part facing the interior of the single cell, and the outer side is a side of the housing part facing away from the cell interior. The insulating element is preferably connectable to the housing parts in an integrally bonded manner, for example by means of a hot pressing process, the connection of the insulating element to the housing parts particularly preferably being designed in such a way that the connection remains over the entire service life of the single cell. The first housing part preferably has a planar design, and the second housing part preferably has a shell-shaped design. Alternatively, both housing parts have a shell-shaped design, at the edge the insulating element enclosing, at least in part, the edge area of a shell-shaped housing part corresponding to the planar housing part.

In a first preferred embodiment, the insulating element has a one-piece design. For this purpose the insulating element has a foil-like design and has dimensions such that it projects, preferably circumferentially, beyond the first housing part at the edge. The projection of the insulating element at the edge is bent by an angle of essentially 180 degrees from the inner side to the outer side of the first housing part, i.e., from the inner side beyond at least one edge to an edge of the outer side of the first housing part, so that the projection has a design corresponding to the edge area of the first housing part, and at the edge therefore has a U-shaped profile, at least in part, in the cross section. For fixing, the projection is permanently sealed to the edge of the outer side of the first housing part. The one-piece design of the insulating element allows simple manufacture of same. In addition, the risk of non-seal-tight connecting points is reduced by closing off the single cell.

In a second preferred embodiment, the insulating element is formed from at least two parts, a first part having a planar design, at least in part, and a second part having a frame-like design.

The first part, corresponding to the insulating element according to the prior art and the first embodiment, is situated with its outer side completely at an inner side of the first housing part, and the second part is situated with its inner side at an edge area of the outer side of the first housing part. When the single cell is closed off, projections are joined together at least in an integrally bonded manner in such a way that the edge area of the first housing part is completely or at least essentially completely enclosed by the insulating element. Manufacture of the single cell is simplified and cost-effective using the second embodiment, since no additional sealing processes are necessary.

The insulating element is preferably made of an electrically insulating material or at least coated with an electrically insulating material, thus ensuring sufficient electrical insulation of the housing parts from one another.

The invention further relates to a battery having a number of single cells which are designed according to the preceding description. As a result of the pole contacts being situated in the middle area of the particular pole side of the electrode foil stack and angled parallel to the pole side, the dimensions of the battery may also be decreased, thus reducing installation space requirements for situating the battery and likewise reducing the weight of the battery.

The battery is preferably a vehicle battery, in particular a traction battery of an electric vehicle, a hybrid vehicle, or a vehicle operated with fuel cells.

### BRIEF DESCRIPTION OF THE DRAWING FIGURES

Exemplary embodiments of the invention are explained in greater detail below with reference to the drawings, which show the following:

FIG. 1 schematically shows a single cell in an exploded illustration according to the prior art,

FIG. 2 schematically shows a perspective view of the single cell according to FIG. 1, in the assembled state,

FIG. 3A schematically shows a sectional illustration of an enlarged detail of the single cell according to the prior art before it is closed off,

FIG. 3B schematically shows a sectional illustration of an enlarged detail of the single cell according to the prior art after it is closed off,

FIG. 4 schematically shows a perspective view of an enlarged detail of the single cell according to the prior art,

FIG. 5 schematically shows a sectional illustration of an enlarged detail of a single cell according to the invention, in a first embodiment,

FIG. 6 schematically shows a perspective view of an enlarged detail of a first housing part, together with an insulating element of the single cell according to FIG. 5,

FIG. 7 schematically shows a perspective view of an enlarged detail of the single cell in the assembled state according to FIG. 5,

FIG. 8A schematically shows a sectional illustration of an enlarged detail of a single cell according to the invention, in a second embodiment before it is closed off, and

FIG. 8B schematically shows a sectional illustration of an enlarged detail of the single cell according to FIG. 8A, after it is closed off.

Mutually corresponding parts are provided with the same reference numerals in all figures.

### DETAILED DESCRIPTION

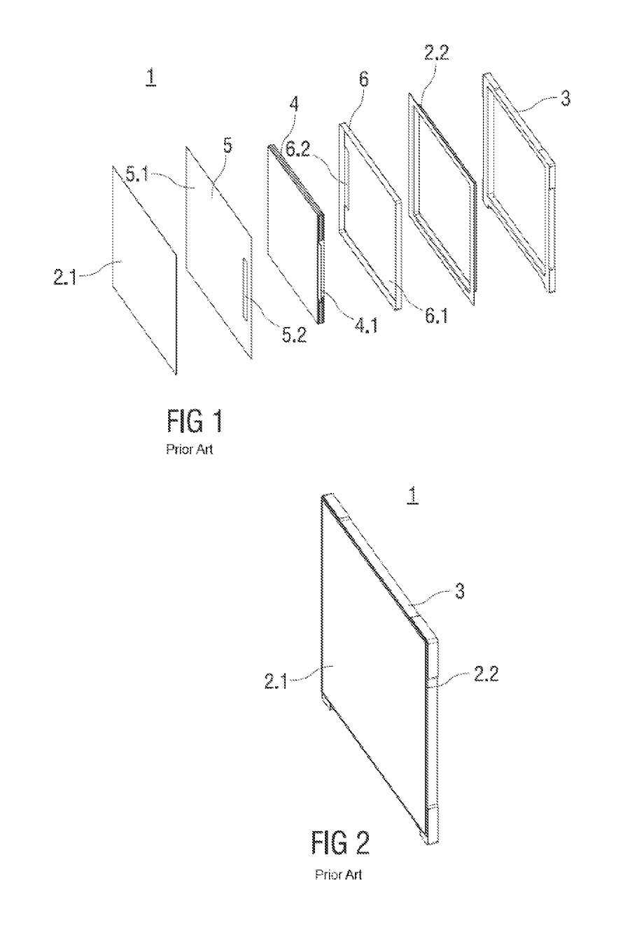

The single cells 1 illustrated in each of FIGS. 1 through 8A are a component of a battery, in particular a vehicle battery in the form of a traction battery for an electric vehicle, a hybrid vehicle, or a vehicle operated with fuel cells.

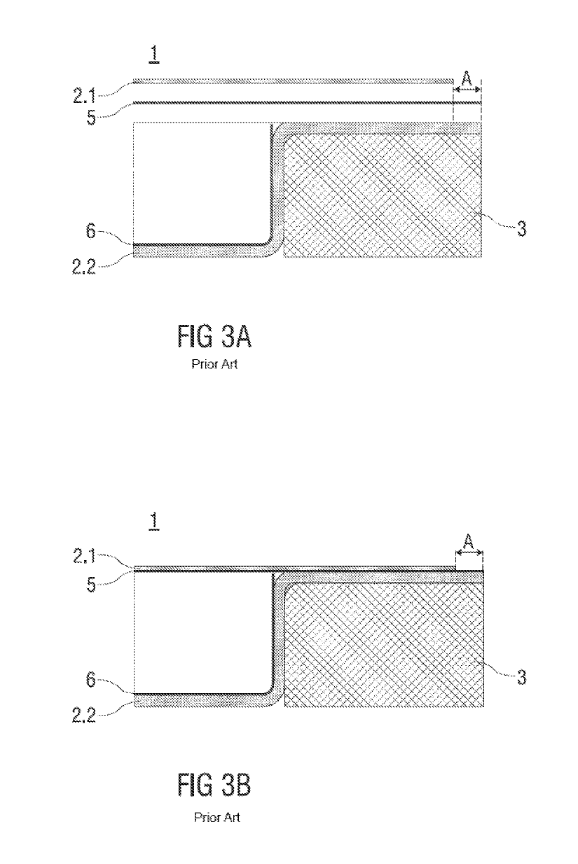

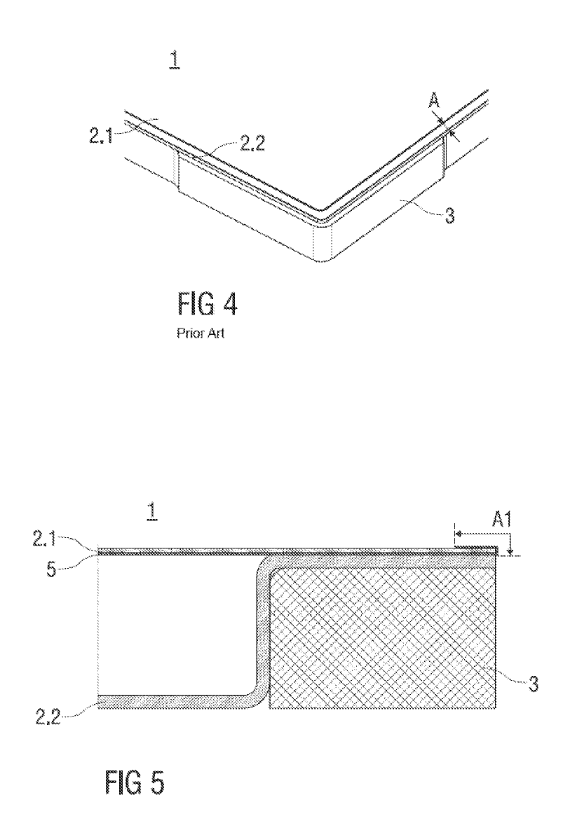

FIGS. 1 through 4 show a single cell 1 according to the prior art, FIG. 1 showing an exploded illustration of the single cell 1, FIG. 2 showing the single cell 1 in the assembled state, FIGS. 3A and 3B each showing a longitudinal section of the single cell 1 before and after, respectively, the single cell is closed off, and FIG. 4 showing an enlarged detail of the single cell 1 in a perspective view.

The single cell 1 according to the prior art has a first housing part 2.1, a second housing part 2.2, and a cell frame 3.

To avoid diffusion of substances such as hydrogen outside the single cell 1 into the interior of the single cell 1 and to largely avoid diffusion of electrolyte out of the single cell 1, preferably a major portion of the housing parts 2.1, 2.2 is made of metal.

In addition, all sides of the second housing part 2.2 are bent at an angle of at least 90° at the edge. The second housing part 2.2 thus has the design of a shell (shell-shaped housing part), and the first housing part 2.1 has the planar design of a plate (plate-shaped housing part), the first housing part 2.1 being used, for example, as the cathode and the second housing part 2.2 being used as the anode. In addition, the second housing part 2.2 has larger dimensions than the first housing part 2.1, so that in the assembled state of the single cell 1 the second housing part 2.2 projects beyond the first housing part 2.1 at the edge, forming a predefinable projection A. This is illustrated in greater detail in particular in FIGS. 3A and 3B.

An electrode foil stack 4 formed from electrode foils, preferably coated copper foils and coated aluminum foils, is situated between the housing parts 2.1, 2.2, a separator foil for spatially separating the electrode foils being situated in each case between the copper foils and the aluminum foils. A separator foil is preferably situated on both sides of the electrode foil stack 4 and closes off same, so that the electrode foil stack 4 is separated with respect to the housing parts.

A section of the electrode foils is led out, uncoated, from the electrode foil stack 4 at each pole side of the electrode foil stack 4, this protruding area of an electrode foil being referred to as a current discharge tab.

For forming a pole contact 4.1, the current discharge tabs of the electrode foils having one polarity are connected to one another; i.e., the current discharge tabs are tacked together. For forming a pole, in each case a pole contact 4.1 of a pole side of the electrode foil stack 4 is connected to an inner side of the respective housing part 2.1, 2.2. For this purpose, during production of the single cell 1 the pole contacts 4.1 are fastened to the particular housing part 2.1, 2.2 in a pressing process and/or fusion welding process, for example resistance spot welding, ultrasonic welding, or laser welding.

Additionally or alternatively, it is conceivable for the particular pole contact 4.1 to be fastened to the corresponding housing part 2.1, 2.2 in a force-fit manner, for example by riveting.

To spatially separate and thus electrically insulate the two housing parts 2.1, 2.2 from one another, which as poles of the single cell 1 conduct voltage during operation of same, an insulating element 5 is situated between the first housing part 2.1 and the electrode foil stack 4. In the assembled state of the single cell 1, the insulating element 5 is situated with its entire outer side, i.e., a side facing the first housing part 2.1, at the inner side of the first housing part 2.1, and is situated with its inner side at the edge, i.e., a side facing the electrode foil stack 4, at an edge area of the inner side of the second housing part 2.2.

To electrically insulate the electrode foil stack 4 from the second housing part 2.2, an insulating shell 6 is situated between same.

For this purpose, the insulating element 5 and the insulating shell 6 are made of an electrically insulating material such as plastic, or are at least coated with an electrically nonconductive material, the insulating element being made of a thermoplastic material, at least in the area of contact with the first and second housing parts 2.1, 2.2. The insulating element 5 and the insulating shell 6 are preferably producible by deep drawing. Since plastic usually has a low diffusion barrier effect, which may result in loss of electrolyte from the single cell 1, the insulating element 5 preferably has a foil-like design.

The foil-like design of the insulating element 5 is not able to ensure sufficient electrical insulation between the housing parts 2.1, 2.2. For example, current flows may occur between the housing parts 2.1, 2.2 due to soiling and moisture, which may result in undesirable discharges of the single cell, and even short circuits.

For this reason, the insulating element 5 is enlarged beyond the edge of one of the housing parts 2.1, 2.2—in the exemplary embodiment, the first housing part 2.1. This means that the insulating element 5 has dimensions such that in the assembled state of the single cell 1 the insulating element projects, at least in part, beyond the first housing part 2.1, forming a projection A, as illustrated by way of example in FIGS. 3A and 3B. The projection A of the insulating element 5 has a design corresponding to the projection A of the second housing part 2.2.

Depending on soiling and possible penetration of moisture over the service life of the battery, the insulating element 5 is enlarged with a projection A of 1.5 millimeter, for example. Due to the mechanical sensitivity of the insulating element 5, the projection A of the insulating element 5 is sealed onto the projection A of the second housing part 2.2. The projection A of the insulating element 5 thus forms a so-called leakage path, which is defined as the shortest distance between the two housing parts 2.1, 2.2 along the free surface, i.e., a side of the insulating element 5 facing the external surroundings of the single cell 1. So-called leakage currents may occur along the leakage path due to soiling or moisture, so that a sufficiently large leakage path is necessary to ensure electrical insulation of the housing parts 2.1, 2.2 from one another.

On their largest side 5.1, 6.1 with regard to area, the insulating element 5 and the insulating shell 6 have a rectangular cutout 5.2, 6.2, respectively, through which in each case a pole contact 4.1 of the electrode foil stack 4 may be led during assembly of the single cell 1. If the electrode foil stack 4 is situated in the insulating element 5 and the insulating shell 6, and the pole contacts 4.1 are led through the cutouts 5.2, 6.2, respectively, the module thus formed is situated in the second housing part 2.2. A pole contact 4.1 of the electrode foil stack 4 lies against the inner side of the second housing part 2.2, and is preferably connected thereto at least in an integrally bonded manner.

For closing off the single cell 1, a hot press process is preferably used in which the first and second housing parts 2.1, 2.2 are pressed onto the insulating element 5 and the insulating shell 6, respectively, for example by means of heated pressing plates of a hot press.

FIG. 5 illustrates a longitudinal section of an enlarged detail of a single cell 1 according to the invention, in a first embodiment.

The single cell 1 has two housing parts 2.1, 2.2, an insulating element 5, a cell frame 3, and an electrode foil stack 4 and an insulating shell 6, not illustrated in greater detail.

To design the single cell 1 with comparatively low space requirements, in a way that optimizes installation space and achieves a leakage path necessary for electrically insulating the housing parts 2.1, 2.2 from one another, it is provided according to the invention that the first housing part 2.1, which has a planar design, is enclosed at least in part by the insulating element 5 at the edge. The first housing part 2.1 is preferably circumferentially enclosed by the insulating element 5 at the edge. According to the prior art, the insulating element 5 has a foil-like design, a projection A1 of the insulating element 5 being guided at at least one edge from the inner side to the outer side of the first housing part 2.1.

As is apparent in the present illustration in FIG. 5, in the assembled state of the single cell 1 the insulating element 5 at the edge thus has a U-shaped profile in the cross section.

In other words, the projection A1 of the insulating element 5 at the edge is bent by an angle of essentially 180 degrees from the inner side to the outer side of the first housing part 2.1, so that the projection A1 has a design corresponding to the edge area of the first housing part 2.1.

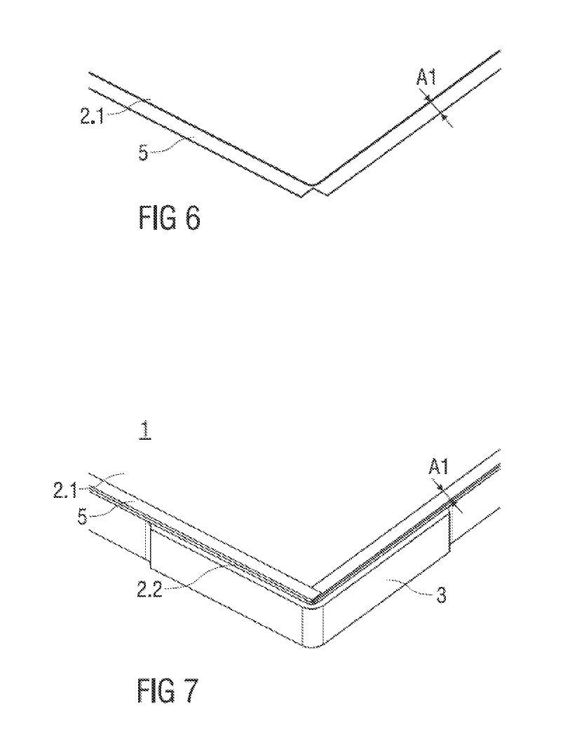

FIG. 6 shows the projection A1 of the insulating element 5 prior to the sealing on the outer side of the first housing part 2.1. The projection A1 has a material relief which intersects a corner of two edges of the first housing part 2.1. The projection A1 preferably has four material reliefs, each of which intersects a corner of the first housing part 2.1. The projection A1 is subsequently laid or folded over the edges on the outer side of the first housing part 2.1, and is sealed thereto, utilizing the adhesive effect of the projection.

In this regard, FIG. 7 shows an enlarged detail of the single cell 1 in the assembled state, and with the projection A1 folded over the insulating element 5.

The first housing part 2.1 is thus circumferentially enclosed by the insulating element 5 at the edge.

The first embodiment of the single cell 1 allows simple manufacture of the insulating element 5, and thus of the single cell 1. In addition, the risk of non-seal-tight connecting points is reduced.

Furthermore, the second housing part 2.2 can thus be produced with dimensions such that in the assembled state of the single cell 1 the second housing part terminates at the first housing part 2.1 at the edge, which allows a reduction in installation space and manufacturing costs of the single cell 1.

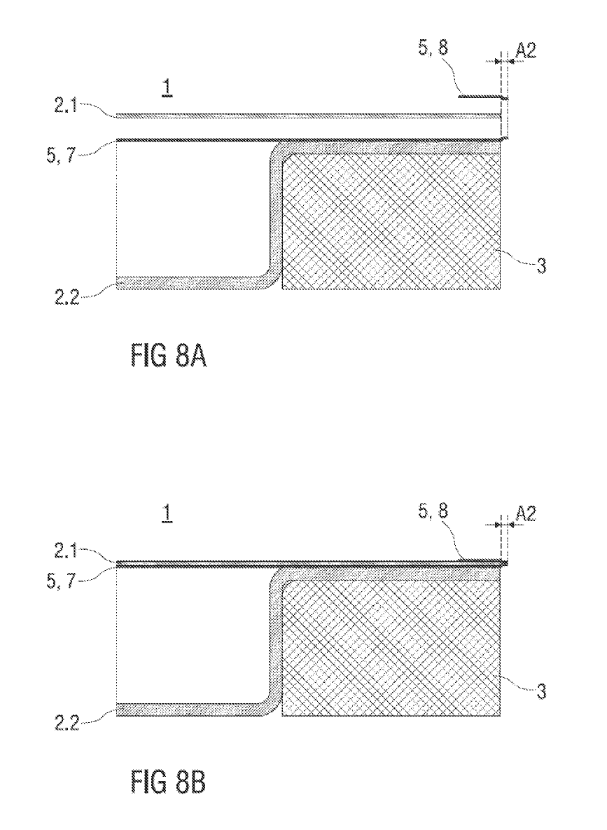

FIGS. 8A and 8B show a longitudinal section of a single cell 1 according to the invention in a second embodiment, FIG. 8A illustrating the single cell 1 before it is closed off, and FIG. 8B illustrating the single cell 1 after it is closed off.

In this embodiment, the insulating element 5 is formed from two parts 7, 8, a first part 7 having a planar design and a second part 8 having a frame-like design.

The first part 7 is situated between the first housing part 2.1 and the electrode foil stack 4, equivalent to the insulating element 5 according to the prior art and the first embodiment of the single cell 1.

In addition, the first part 7 has dimensions such that in the assembled state of the single cell 1 the first part projects beyond the first and second housing parts 2.1, 2.2, forming a projection A2. In the present exemplary embodiment, the projection A2 is bent by an angle of less than 90 degrees in the direction of the first housing part 2.1.

The second part 8 is situated on an edge area of the outer side of the first housing part 2.1 in such a way that the second part projects beyond the first and second housing parts 2.1, 2.2 at the edge, forming a projection A2, the dimensions of the projection A2 of the second part 8 having a design corresponding to the dimensions of the projection A2 of the first part 7. In the present exemplary embodiment, the projection A2 of the second part 8 is bent by an angle of less than 90 degrees in the direction of the second housing part 2.2.

The projections A2 of the parts 7, 8 of the insulating element 5 preferably have dimensions which are smaller than the projection A1 of the insulating element 5 according to the first embodiment of the single cell 1.

When the single cell 1 is closed off, preferably by hot pressing, the projections A2 are joined together at least in an integrally bonded manner in such a way that the edge area of the first housing part 2.1 is completely or at least essentially completely enclosed by the insulating element 5. Therefore, no additional sealing processes are necessary, so that manufacture of the single cell 1 is simplified and cost-effective.

The parts 7, 8 of the insulating element 5 are preferably made of the same material, or have the same electrically insulating coatings in the material. Alternatively, it is also possible to use different materials or coatings for the parts 7, 8.

In an alternative embodiment of the invention not illustrated, the housing parts 2.1, 2.2 each have a shell-shaped design, at the edge the insulating element 5 enclosing the edge area of one of the shell-shaped housing parts 2.1, 2.2 in a manner equivalent to the first housing part 2.1 having a planar design. It is also conceivable for both housing parts 2.1, 2.2 to have a planar design.

As a result of the first housing part 2.1, in comparison to the prior art, being enclosed by the insulating element 5 at the edge, the dimensions of the second housing part 2.2 and thus also of the cell frame 3 may be reduced. The single cell 1 is thus reducible in size, so that material use in the manufacture of the housing parts 2.1, 2.2 may be decreased. In addition, weight savings of the single cell 1 are achievable due to the decreased material use.

If the single cell 1 is a component of a battery, in particular a vehicle battery, which contains a predefinable number of single cells 1 of this type of design, the battery i.e., a battery housing corresponding to the dimensions of the single cells 1, may be reduced in size, thus decreasing installation space requirements for situating the battery and likewise reducing the weight of the battery.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS/CHARACTERS

1 Single cell
2.1 First housing part
2.2 Second housing part
3 Cell frame
4 Electrode foil stack
4.1 Pole contacts
5 Insulating element
5.1 Largest side with regard to area
5.2 Cutout
6 Insulating shell
6.1 Largest side with regard to area
6.2 Cutout
7 First part
8 Second part
A, A1, A2 Projections

1-9. (canceled)

10. A single cell for a battery, comprising:
first and second housing parts;
a cell frame;
an electrode foil stack situated between the first and second housing parts; and
an insulating element, situated between the first and second housing parts in such a manner that the first and second housing parts are electrically separated from one another,
wherein the insulating element has dimensions such that in the assembled state of the single cell the insulating element projects, at least in part, beyond the first housing part at an edge, forming a projection,
wherein the first housing part is enclosed, at least in part, by the insulating element at the edge.

11. The single cell according to claim 10, wherein at the edge, the insulating element is guided at at least one edge from an inner side to an outer side of the first housing part.

12. The single cell according to claim 10, wherein the insulating element is a single piece.

13. The single cell according to claim 12, wherein the insulating element at the edge has a U-shaped profile, at least in part, in a cross section.

14. The single cell according to claim 10, wherein the insulating element is comprised of two parts, a first part having a planar design, at least in part, and a second part having a frame-like design.

15. The single cell according to claim 14, wherein the first part is situated with its outer side at an inner side of the first housing part, and the second part is situated with its inner side at an outer side of the first housing part, projections of the first and second parts being joined together at least in an integrally bonded manner.

16. The single cell according to claim 10, wherein the insulating element is made of an electrically insulating material or is at least coated with an electrically insulating material.

17. A battery comprising:
a plurality of single cells, each of the plurality of single cells comprising
first and second housing parts;
a cell frame;
an electrode foil stack situated between the first and second housing parts; and
an insulating element, situated between the first and second housing parts in such a manner that the first and second housing parts are electrically separated from one another,
wherein the insulating element has dimensions such that in the assembled state of the single cell the insulating element projects, at least in part, beyond the first housing part at an edge, forming a projection,
wherein the first housing part is enclosed, at least in part, by the insulating element at the edge,
wherein the plurality of single cells are electrically connected to each other.

18. The battery according to claim 17, wherein the battery is a traction battery of an electric vehicle, a hybrid vehicle, or a vehicle operated with fuel cells.
